(19) United States
(12) Patent Application Publication
(10) Pub. No.: US 2026/0304326 A1
(43) Pub. Date: Oct. 1, 2026

(54) METHODS AND DEVICES FOR FACILITATING CONFIGURATION OF UPLINK OUTPUT POWER OF WIRELESS TERMINAL

(71) Applicant: Sony Group Corporation, Tokyo (JP)

(72) Inventors: Kun ZHAO, Malmö (SE); Fredrik RUSEK, Eslöv (SE)

(21) Appl. No.: 19/480,815

(22) PCT Filed: Apr. 12, 2024
(86) PCT No.: PCT/EP2024/059954

§ 371 Date: Nov. 2, 2025

(30) Foreign Application Priority Data
May 15, 2023 (SE) 2350589-4

(51) Int. Cl. H04W 52/14; H04W 52/36; H04W 52/42

(52) U.S. Cl. CPC H04W 52/146; H04W 52/367; H04W 52/42

(57) ABSTRACT

A method carried out in a user equipment, UE, for facilitating configuration of uplink, UL, output power of radio transmission from the UE, wherein the method comprises: receiving (402), from an access network, a first message indicative of a first configuration of maximum output power for at least a first UL beam and a second UL beam; transmitting (406), to the access network based on the first message, information indicative of resulting output power of using the first UL beam and the second UL beam according to the first configuration.

### TECHNICAL FIELD

Solutions provided herein are associated with configuration and management of output transmission power in a wireless terminal operating in a radio communication network. Specifically, solutions are provided for facilitating configuration of transmit power for a multi-panel wireless device, when configured to transmit in multiple beams.

### BACKGROUND

Radio communication systems operating under various iterations of the 3^{rd} Generation Partnership Project (3GPP) offer high peak data rates, low latency, improved system capacity, and low operating cost resulting from simple network architecture. These include inter alia Long-Term Evolution (LTE) system and more recently so called 5G networks and New Radio (NR). Orthogonal frequency division multiplexing (OFDM) radio technology has been incorporated to enable high data bandwidth to be transmitted efficiently while still providing a high degree of resilience to reflections and interference. In such radio communication systems, the transmit power of each mobile terminal, also referred to as User Equipment (UE), needs to be maintained at a certain level and regulated by the network. The maximum transmit power capacity of each UE, however, is different depending on UE capability and situation. Power headroom report (PHR) is a mechanism to configure the UE to provide its power capacity and usage to the network. A UE uses PHR mechanism to periodically provide its serving base station with its power headroom (PH), which is defined as a power offset between a UE-configured maximum transmit power and a UE-calculated current UE transmit power. Based on the received PH information, the eNB can regulate the UE transmit power with proper resource allocation.

When operating a UE in the mm Wave frequencies the functionality of beamforming is essential, since it—contrary to an omnidirectional transmission—allows transmissions to be directed so that the signal to noise ratio is improved. However, there are restrictions to handle maximum exposure of signal energy to a user utilizing the UE. Hence, it has been concluded in 3GPP that the UE in FR2 (Frequency Range 2—spectrum within the mm wave range) will likely face critical restriction related to output power due to the governments and regulators' limitations.

One potential issue relates to the regulatory power limitation when multiple panels of the UE transmit simultaneously. Regulators usually enforce limitations on output power, computed in two ways: total radiated power (TRP) and equivalent isotropic radiation power (EIRP); these limitations are due to co-existence and human exposure limits. How to meet those limits is clear when only a single panel is. However, it is not very straightforward to place those upper limits when multiple panels (e.g., multiple transmitters) transmit simultaneously. This concerns for instance EIRP since the total EIRP for two (or more) simultaneous transmitters cannot simply be determined from the individual output power levels. In fact, spatial relation between the uplink (UL) beams impacts the EIRP calculation.

In this context, it may be noted that two parameters are defined for limiting the UE maximum EIRP:
1. Maximum allowed EIRP
2. MPE (Maximum Permitted Exposure) limitation

These are related to some extent but not on exactly the same level. Dependent on the device type and operation conditions, one of the two may be dominate.

From 3GPP perspective, MPR (Maximum Power Reduction) is a mechanism configured with respect to maximum allowed EIRP. Moreover, P-MPR (Power management Maximum Power Reduction) is a mechanism configured for MPE limitations.

For reference, FIG. 1 schematically illustrates such impact for three different cases. The top case illustrates use of two beams pointing in substantially different directions. Here, the two beams are sufficiently well separated so that the total EIRP is the maximum of the individual EIRPs. The middle case illustrates use of two beams pointing in substantially the same direction, and the lower case illustrates use of two beams pointing in different directions but with strong side lobes. In the two lower cases, the total EIRP may exceed either the peak EIRP of panel 1 and/or the peak EIRP of panel 2 due to the constructively added power from the two panels at a certain direction.

When the total EIRP exceeds the upper limitation that is allowed by regulators or by 3GPP, power backoff is needed, which can result a degraded the uplink performance, and the selected beam pair may not be optimal anymore.

There consequently exists a need for a solution for configuring transmit power of a UE in a radio communication network, where the UE is capable of multi-panel transmission concurrently using a plurality of UL beams.

### SUMMARY

Solutions are provided herein which target the identified need. These solutions are provided in the independent claims, and various embodiments are set out in the dependent claims.

According to a first aspect, a method carried out in a UE is provided for facilitating configuration of UL output power of radio transmission from the UE, wherein the method comprises:
receiving, from an access network, a first message indicative of a first configuration of maximum output power for at least a first UL beam and a second UL beam;
transmitting, to the access network based on the first message, information indicative of resulting output power of using the first UL beam and the second UL beam according to the first configuration.

According to a second aspect, a method carried out in an access node of an access network is provided for configuration of UL output power of radio transmission from a UE, wherein the method comprises:
transmitting, to the UE, a first message indicative of a first configuration of maximum output power for at least a first UL beam and a second UL beam;
receiving, from the UE, information indicative of resulting output power of using the first UL beam and the second UL beam, wherein UL connection for the UE is configured based on said information.

According to a third aspect, a method carried out in a UE is provided for facilitating configuration of UL output power of radio transmission from the UE, wherein the method comprises:
transmitting, to the access network, information indicative of resulting output power of concurrently using a first UL beam and a second UL beam for UL transmission;
receiving, from an access network, a message indicative of a first configuration of maximum output power for at least a first UL beam and a second UL beam, based on the information.

According to a fourth aspect, a method carried out in an access node of an access network is provided for configuration of UL output power of radio transmission from a user equipment, UE, wherein the method comprises:
receiving, from the UE, information indicative of resulting output power of concurrently using a first UL beam and a second UL beam for UL transmission;
transmitting, to the UE, a message indicative of a first configuration of maximum output power for at least a first UL beam and a second UL beam, based on the information.

According to further aspects, a UE and an access node are provided, configured to operate in accordance with the outlined methods.

By means of the proposed solutions, improved methods and devices are provided for configuration of a multi panel UE while considering regulatory restrictions related to transmitted power.

### BRIEF DESCRIPTION OF THE DRAWINGS

FIG. 1 schematically illustrates different scenarios of UL transmission from a multi-panel UE.

FIG. 2 schematically illustrates a radio communication network and communication between a radio network node and a radio terminal according to various examples of the proposed solution.

FIG. 3 schematically illustrates a UE configured to operate according to various embodiments.

FIG. 4 schematically illustrates method steps carried out by a UE according to various embodiments.

FIG. 5 schematically illustrates a radio node of a Radio Access Network (RAN) configured to operate according to various embodiments.

FIG. 6 schematically illustrates method steps carried out by a radio node according to various embodiments.

FIG. 7 schematically illustrates a signaling diagram between different entities of a system according to various embodiments.

FIG. 8 schematically illustrates a signaling diagram between different entities of a system according to various further embodiments.

### DETAILED DESCRIPTION

In the following description, for purposes of explanation and not limitation, details are set forth herein related to various embodiments. However, it will be apparent to those skilled in the art that the proposed solution may be practiced in other embodiments that depart from these specific details. In some instances, detailed descriptions of well-known devices, circuits, and methods are omitted so as not to obscure the description of the proposed solution with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before presenting aspects and examples of the proposed solution, context and devices for use of the proposed solution will be briefly described with reference to the drawings. The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

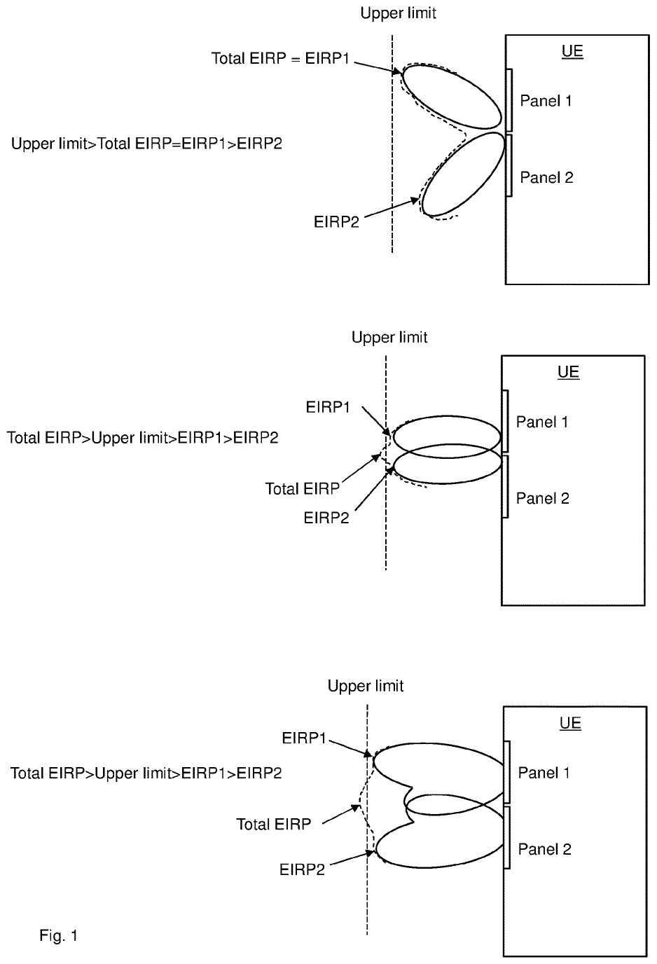

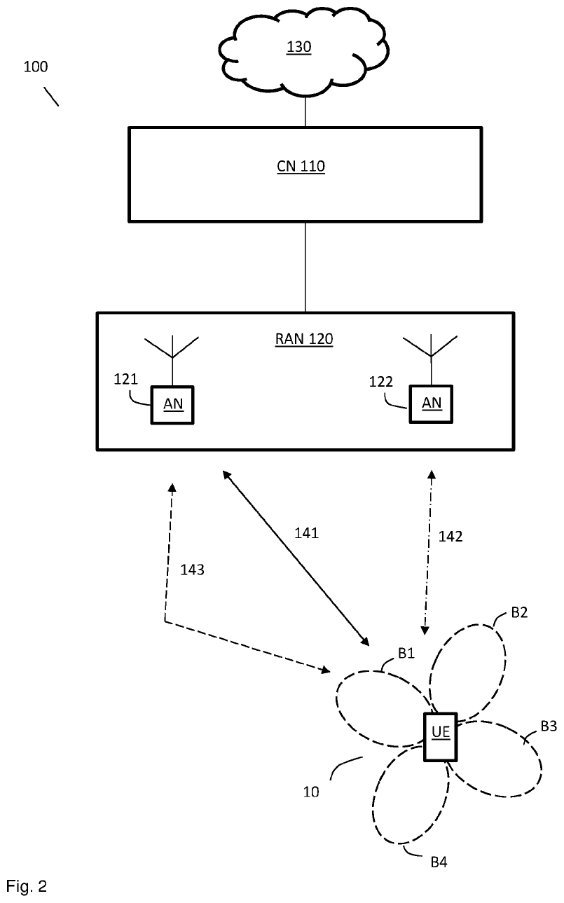

FIG. 2 illustrates a high-level perspective of operation of a UE 10 in a wireless system, configured to communicate with a wireless communication network 100. FIG. 1 is useful for context of the proposed solution and illustrates various entities and functions which cooperate in wireless system.

The wireless network 100 may be a radio communication network 100, configured to operate under the provisions of 5G as specified by 3GPP, according to various examples, or further generations.

The wireless network 100 may comprise a core network (CN) 110, connectable to an external network 130 such as the Internet. The core network may comprise a plurality of core network nodes, which realize logical functions. For the example of a 5G system, this may, inter alia, include the Access and Mobility Management Function (AMF), a Session Management Function (SMF), a User Plane Function (UPF), a Network Exposure Function (NEF), a Policy Control Function (PCF), all of which are legacy functions of the 5G system (5GS).

The wireless network 100 further comprises a Radio Access Network (RAN) 120, or access network for short, comprising a plurality of access nodes (AN) including the shown access nodes 121 and 122, configured for radio communication with wireless devices including the UE 10.

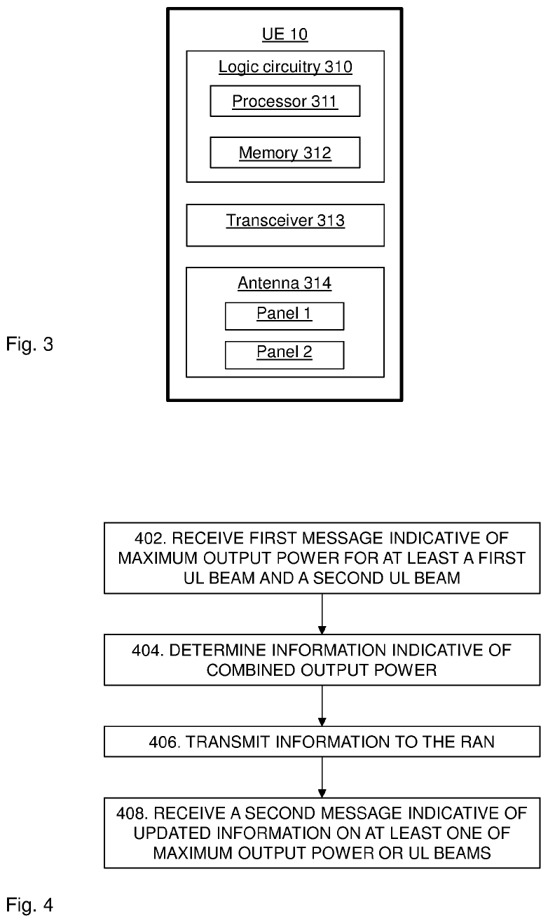

FIG. 3 schematically illustrates an example of the UE 10 for use in a wireless network 100 as presented herein and configured for carrying out various method steps as outlined. Some relevant elements or functions of the UE 10 are shown in the drawing. The UE 10 may however include other features and elements than those shown in the drawing or described herein, such as power supply, a casing, a user interface, sensors, etc., but these are left out for the sake of simplicity.

The UE 10 comprises a radio transceiver 313, also referred to herein as modem 313, for communicating with other entities of the radio communication network 100, such as the access node 121, in one or more frequency bands. The transceiver 313 may thus include at least one receiver chain (Rx) and at least one transmitter chain (Tx), for communicating through at least an air interface, referred to as Uu in 3GPP. The transceiver 313 may be or comprise a modem configured to encode, transmit, receive and decode data using radio waves.

The UE 10 further comprises an antenna system 314, which may include one or more antennas, antenna ports or antenna arrays. The antenna system 314 is configured for spatial sensitivity, such that transmission and reception in the mm wave region can be selectively configured to be directed or focused in different directions. In this context, the antenna system is usable for concurrent communication in two or more beams. The antenna system 314 may thus comprise a plurality of antenna panels, such as indicated Panel 1 and Panel 2, which correlates with the reference numerals of FIG. 1 for the sake of convenience. Each of the plurality of panels may be concurrently operated in connection with a separate transmitter and/or receiver of the radio transceiver 313. This may be referred to as a multi-panel system. Configuration of beams may be realized by configuring an antenna array of each respective panel to provide an anisotropic sensitivity profile to transmit (or receive) radio signals in a particular transmit direction.

The UE 10 further comprises logic circuitry 310 configured to control data and signal communication via the radio transceiver on one or more physical channels to a serving access node 121 of the wireless network 100, and optionally to one or more additional access nodes 122. The logic circuitry is further configured to control the UE to carry out any of the steps associated with the proposed solution as outlined herein.

The logic circuitry 310 may include a processing device 311, including one or multiple processors, microprocessors, data processors, co-processors, and/or some other type of component that interprets and/or executes instructions and/or data. The processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, the memory storage 312 may include a random access memory (RAM), a dynamic random access memory (DRAM), a cache, a read only memory (ROM), a programmable read only memory (PROM), flash memory, and/or some other type of memory. The memory storage 312 may include a hard disk (e.g., a magnetic disk, an optical disk, a magneto-optic disk, a solid state disk, etc.). The memory storage 312 is configured for holding computer program code, which may be executed by the processing device 311, wherein the logic circuitry 310 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 310.

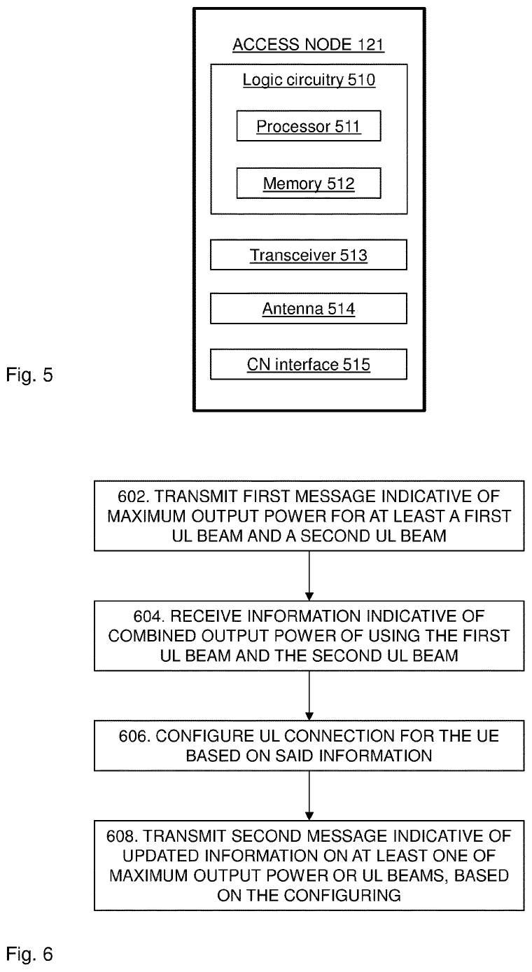

FIG. 5 schematically illustrates a radio node in the form of an access node 121 of the RAN 120 of the wireless network 100 as presented herein, and for carrying out the method steps as outlined. An access node 121 may have one or more transmission and reception point(s) TRP(s). In various examples, the access node 121 is a radio base station for operation in the radio communication network 100, to serve one or more radio UEs, such as the UE 10. The access node 121 may be configured to operate as a gNB of a 5G system.

The access node 121 comprises a wireless transceiver 513, such as a radio transceiver for communicating with other entities of the radio communication network 100, such as the terminal 10. The transceiver 513 may thus include at least one radio receiver and at least one radio transmitter for communicating through over an air interface.

The access node 121 may further comprise, or be connected to, an antenna 514, which may include an antenna array. Physical location of the antenna 514 defines the location of the TRP of the access node 121. The antenna is connected to the transceiver 513. The antenna 514 is configured for spatial sensitivity, such that transmission and reception in the mm wave region can be selectively configured to be directed or focused in different directions. In this context, the antenna 514 may be usable for concurrent communication in two or more beams. The antenna 514 may thus comprise one or more antenna panels. The antenna 514 may be configured to operate in the mm wave region and may apply the concept of beam sweeping according to 3GPP specifications.

The access node 121 further comprises logic circuitry 510 configured to control the access node 121 to communicate with the UE 10 via the radio transceiver 513 on a physical channel. The logic circuitry 510 may realize a scheduler for scheduling communication of a data set and allocating resources according to the scheduling according to the solutions proposed herein, and for configuring the UE to operate according to the scheduling, based on a related QoS.

The logic circuitry 510 may include a processing device 511, including one or multiple processors, microprocessors, data processors, co-processors, and/or some other type of component that interprets and/or executes instructions and/or data. Processing device 511 may be implemented as hardware (e.g., a microprocessor, etc.) or a combination of hardware and software (e.g., a system-on-chip (SoC), an application-specific integrated circuit (ASIC), etc.). The processing device 511 may be configured to perform one or multiple operations based on an operating system and/or various applications or programs.

The logic circuitry 510 may further include memory storage 512, which may include one or multiple memories and/or one or multiple other types of storage mediums. For example, memory storage 512 may include a random access memory (RAM), a dynamic random access memory (DRAM), a cache, a read only memory (ROM), a programmable read only memory (PROM), flash memory, and/or some other type of memory. Memory storage 512 may include a hard disk (e.g., a magnetic disk, an optical disk, a magneto-optic disk, a solid state disk, etc.). The memory storage 512 is configured for holding computer program code, which may be executed by the processing device 511, wherein the logic 510 is configured to control the access node 121 to carry out any of the method steps as provided herein. Software defined by said computer program code may include an application or a program that provides a function and/or a process. The software may include device firmware, an operating system (OS), or a variety of applications that may execute in the logic 510.

The access node 121 may further comprise at least one an interface 515, configured for communication with the core network 110.

For the purpose of visualization, FIG. 2 schematically illustrates that the UE 10 may be configured to communicate using more than one spatial configuration (direction and width) B1-B4. These configurations may be considered as UE beams. These configurations, or beams, B1-B4 may be orthogonal in terms of coding and/or frequency division and/or time division, and each beam may be configured by one of the plurality of panels of the antenna system 314.

The UE 10 may be configured, using the multi-panel system of the antenna system 314, to communicate on a first channel 141 with a first access node 121, such as a serving access node. A so-called beam-pair may be configured by the access node 121, wherein the beam pair comprises one Tx beam and one Rx beam of the access node (or TRP) 121. At least one panel, e.g., Panel 1, of the UE 10 may be configured to communicate with the access node 121 using a first beam-pair of the access node 121, as indicated by 141. This may e.g., be accomplished by configuring Panel 1 to obtain spatial sensitivity B1 substantially aligned with the first beam pair of the access node 121. For uplink (UL) communication, the spatial configuration of the antenna system 314 identifies a first UL beam of the UE 10, for communication on channel 141.

Additionally, another panel, e.g., Panel 2, of the UE 10 may be configured to communicate with sensitivity using a different spatial configuration B2. In one example, such additional communication may comprise communication over a channel 142 with a second access node (TRP) 122. In another example, additional communication may comprise communication or over a channel 143 with the same first access node, e.g., using a second beam-pair of that first access node 121. For UL communication, the spatial configuration of the antenna system 314 identifies a second UL beam of the UE 10, for communication on channel 142 or 143.

Specifically, the UE 10 may concurrently communicate over more than one channel using different spatial configuration, and UL beams, by means of the multi-panel system.

Various propositions exist on how to manage moderation of terminal output power, e.g., for transmission in FR2, currently having a Frequency Range Designation of 24250-71000 MHz. This has included defining the maximum uplink duty cycle under peak beam facing human body condition, as the UE capability maxUplinkDutyCycle capability. There are many drawbacks to be considered, though, in the general concept of P-MPR and maxUplinkDutyCycle. As the uplink beam will change from time to time in real life, the solution for mitigating the exposure such as MPE and EIRP must be carried out in a dynamic manner. Existing solutions for mitigating the MPE issue includes the dynamically reporting the maximum uplink duty cycle restriction, as well as the PHR (Power Headroom Report).

The UE 10 is arranged to ensure that limits related to output power, such as total EIRP, are complied with. According to some aspects of the proposed solution, the UE 10 further comprises information indicative of combined limits, or net power effects, for any combination of spatial configurations that the UE 10 can support. For the example of a two-panel system as shown in FIG. 3, each of Panel 1 and Panel 2 may be tuned to a number of different spatial sensitivity configurations. Each combination of a configuration of Panel 1 and of Panel 2 forms a tuple of configurations, or UL beams, for UL transmission from the UE 10. In this context, it shall be noted that a group of UL beams for UL transmission may be defined, wherein the mentioned tuple relates to the example of two panels, or two separately configurable UL beams. According to the proposed solution, this information indicative of combined limits, or net power effects is used for facilitating power control and/or beam pair selection by the RAN 120, typically the serving access node 121. In this context, the information may be indicative of net EIRP, dependent on the resulting power effects in the direction in which aggregate power is maximum. The information may further be indicative of a functional relationship between the aggregate or net power and the two individual UL beam powers. The functional relationship may be evaluated at the RAN 120 to configure the power control of the first and second UL beams so to satisfy the EIRP limit while also satisfying other targets, such as a throughput target.

The functional relationship may be a simplified one, indicative only of the first and second beams' individual EIRP levels at the direction where net EIRPs of the first and second beams is maximum. This may be reported as reference values computed for the first and second beam operated at maximum EIRP.

According to one example, the UE 10 is configured to report needed power back-off when the access node 121 configures the UE 10 with a certain combination of UL beams from multiple UE panels, so that the UE will not violate limitations or regulations associated with transmitted power, such as maximum allowed EIRP limitations or EMF regulations.

FIG. 4 shows a flow chart of a method carried out in the UE 10 for facilitating configuration of UL output power of radio transmission from the UE 10. According to some examples, the method comprises:

Step 402 comprises receiving, from the RAN 120, a first message indicative of a first configuration of maximum output power for at least a first UL beam and a second UL beam.

According to some examples, the first message is transmitted on MAC (Medium Access Control) layer. In other examples, the first message may be transmitted on PHY (Physical) layer. The first configuration may be indicative of TCI (Transmission Configuration Indicator) states, i.e., a pair of TCI states to which the first and second UL beams shall be configured. The (TCI) states may be dynamically transmitted by the RAN 120 in a DCI (Downlink Control Indicator) message. Another example may comprise indicating beam IDs for the access node 121, where each beam pair (or each UL Rx beam) of the access node 121 has a unique ID. In such an example, the ID rather than TCI state may be signaled.

In some examples, the first configuration may define maximum total combined uplink power for the UE 10. In other examples, the first configuration may define maximum uplink power per panel (i.e., per UL beam). According to further examples, the first configuration may define maximum uplink power, or power back-off, for a certain combination of UL beams, such as an UL beam tuple as exemplified for a two-panel system.

In this context, the first message may be implicitly indicative of UL beams, by identifying beam pairs to use. The first message may comprise radio resource configuration, indicative of resources for use in at least UL communication, using beam pairs corresponding to the first and second UL beams of the UE 10. The UE 10 is typically already configured to communicate with a serving access node 121, wherein the first message may be received using a beam pair associated with the first UL beam. The UE 10 may thus already be configured with a first maximum output power for the first UL beam. The first message may then be indicative of at least the second UL beam, and a second maximum output power for the second UL beam, to be used concurrently with the first UL beam. In another example, the first message may indicate both a first UL beam and a second UL beam and associated maximum output power for the respective UL beam, regardless of the present connection between the UE 10 and the RAN 120. In an alternative example, where the RAN has obtained the mentioned functional relationship between the net power and the two UL beam powers, maximum output power may be indicated by the first and second beams' individual EIRP levels at the direction where aggregate EIRPs of the first and second beams is maximum. In these examples, the first message is nevertheless indicative of at least two UL beams and associated maximum output power. The purpose of configuring connection with two (or more) UL beams may be to increase UL throughput or improve connectivity.

Step 404 identifies determining, based on the first message, information indicative of resulting output power of using the first UL beam and the second UL beam. This may involve determining said information based on the first configuration.

This step may involve assessing the configured information indicative of combined limits, or net power effects, for the combined configuration of the first UL beam and the second UL beam (and any further UL beam indicated by the first message). For example, the first and second UL beam may display maximum constructive interference in a direction D, and when operated individually at maximum EIRP, the first and second beam may have EIRPs E_1 and E_2 in the direction D, respectively. The information may be indicative of the values E_1 and E_2, to facilitate UL configuration by the RAN 120 such that powers P_1 and P_2 of the two UL beams can take any values as long as the relation P_1 E_1+P_2 E_2≤EIRP_max holds.

Step 406 comprises transmitting, to the access network based on the first message, information indicative of resulting output power of using the first UL beam and the second UL beam according to the first configuration.

In some examples, the information indicative of resulting output power may be indicative of or comprise a required power back-off caused by constructive combination of the first UL beam and the second UL beam. In this context, the power back-off may comprise or be related to a power reduction using MPR and/or P-MPR, e.g., as described above and as also identified in 3GPP TS 36.101. In other words, based the received indication of maximum output power for the respective UL beam, and the known combination effect of using the UL beams indicated in the first message, the UE 10 determines how much the output power would need to be reduced, for each of the UL beams or for all UL beams combined.

In some examples, the information indicative of resulting output power may be indicative of resulting output power upon transmitting using maximum output power for a first UL beam and a second UL beam. The information may thus, in this example, indicate the resulting expected output power, as adjusted by power reduction (if any) to counter constructive combination of the first UL beam and the second UL beam, rather than how much reduction would be applied. This may further indicate, to the RAN, how close to being forced to apply a power reduction the UE 10, even if it is not currently required, which can be used for beam and power planning purposes by the RAN 120, and specifically the serving access node 121.

In some examples, the determined and transmitted information may be indicative of required power back-off, or combined output power, resulting from replacing one of said first and second UL beams with a third UL beam. In this context, the UE may report information for more than the UL beams indicated by the first message. This may facilitate beam selection for the access node 121. The UE 10 may e.g., indicate the needed power back-off for detected nearby beam-pairs, which provides another combination (tuple) of UL beams which requires less back-off. Transmission 406 of this information may be used as basis for the access node 121 to select other candidate beams.

In some examples, the step of transmitting 406 is carried out responsive to a parameter value, correlating with the resulting output power, meeting a threshold criterion. In this context, the UE 10 may in some examples be configured to transmit the information responsive to the power back-off exceeding a threshold limit. In another example, the UE 10 may be configured to transmit the information responsive to the resulting output power, as adjusted after power back-off, not falling below a threshold limit. In another example, the UE 10 may be configured to transmit the information responsive to EIRP, responsive to concurrent transmission according to the first configuration, exceeding a threshold limit. Threshold limits may be configured by the RAN 120, be prescribed by specification, be calculated by the UE based on further information, or a combination of any of those examples.

Step 408 indicates receiving, responsive to the transmitted information, a second message associated with the first message indicative of updated information on at least one of maximum output power or UL beams.

The access node 121 may in some examples determine, based on the information indicative of resulting output power, that the indicated required power back-off is acceptable. In this case, the second message may confirm the instructions (beam and maximum power) of the first message, such as by simply transmitting an acknowledgement (ACK) of the received information. In this context, the updated information need not contain any new information, but rather a confirmation or an implicit repetition of the first message, to configure UL communication (at least UL transmission) according to the first message.

In other examples, the second message is indicative of a second configuration comprising an update of at least one of maximum output power or UL beams according to the first configuration. The second message may comprise radio resource configuration, indicative of resources for use in at least UL transmission communication, using different beam pairs than at least one of those corresponding to the first and second UL beams of the UE 10. In this context, the access node 121 may reconfigure beam-pair selection and/or maximum power for one or more of the beams covered by the first message. This may include identifying a third beam as indicated by the information transmitted by the UE 10, as explained for an example above, in addition to or in replacement of one of the beams indicated by the first message. The second message may in some examples comprise an effective withdrawal of use of one of the beams indicated by the first message.

In another example, the second message may comprise an instruction to reconfigure power back-off between the first and second UL beam, while ensuring that limits and regulations related to output power and exposure are met. This may involve re-allocating MPR for the respective UL beam to optimize overall UL performance. This way, in effect, output power P1 and P2 can be individually adjusted while at the same time staying below max EIRP and having good capacity/SNR in the two UL beams. For example, if B1 faces a very bad channel, and B2 a very good, then the system may balance P1 and P2 in order for it to be meaningful to use both beams.

In another example, the second message is indicative of an adjustment of uplink duty cycle for the first configuration. This way, potential MPE violation may be circumvented without (or with) reducing configured maximum output power.

FIG. 6 shows a flow chart of a method carried out in the access node 121 for configuration of UL output power of radio transmission from the UE 10. The steps outlined below are for the most part corresponding and complementary to the steps carried out in the UE 10, as explained with reference to FIG. 4. In some aspects reference may therefore be made to the above description portions. According to some examples, the method comprises:

Step 602 identifies transmitting, to the UE 10, a first message indicative of first configuration of maximum output power for at least a first UL beam and a second UL beam.

In this context, the first message may be implicitly indicative of UL beams, by identifying beam pairs to use. Content, configuration and transmission of the first message may in various examples take any of the forms as described with reference to step 402.

Step 604 identifies receiving, from the UE 10, information indicative of resulting output power of using the first UL beam and the second UL beam. Based on this obtained information, UL connection for the UE may be is configured by the access node 121.

In this context, the information may provide or be indicative of any of the elements and character described with reference to steps 404 and 406.

Step 606 identifies configuring UL connection for the UE 10 based on said information.

This configuring of UL connection may comprise re-allocation of UL resources for the UE 10, such as for configuration the UE 10 to transmit using other UL beams than those indicated by the first message. This may entail allocating resources for using fewer or more beams than indicated by the first message, and/or configuring adjusted uplink duty cycle for the UE 10. In some examples, this step may comprise reconfiguring maximum output power for one or more UL beams.

Step 608 indicates transmitting, responsive to the received information, a second message associated with the first message. The second message may be indicative of updated information on at least one of maximum output power, UL beams, or uplink duty cycle, based on the configuring of step 606.

Configuration and transmission of the second message corresponds to what has been described with reference to step 406 above. The second message may further be transmitted with indications, and on layers, corresponding to the examples outlined above for the first message.

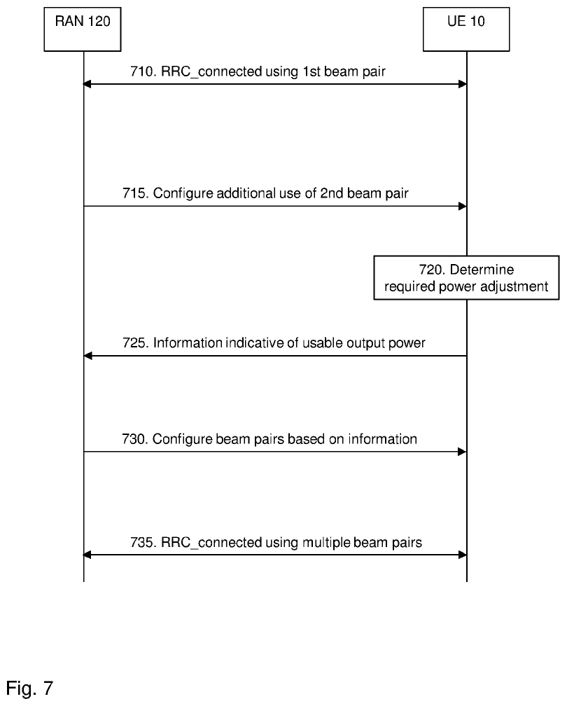

FIG. 7 comprises a signaling diagram, which shows the various steps of FIGS. 4 and 6 together. The left part indicates the RAN 120 and may be carried out by a serving access node 121, or by more than one access node.

710 indicates that the UE 10 is connected (RRC_Connected) with the RAN 120, such as access node 121. Connection may as such be completed without using mm wave communication (FR2), but it is assumed in this example that the UE 10 is configured, by step 710 to communicate with a first UL beam and an associated first maximum output power.

At 715 the RAN configures the UE to additionally use a 2^{nd} beam pair, with an associated second UL beam having a second maximum output power. The second beam pair may be related to the same access node 121, or to another access node 122. The configuring involves transmitting 602, for reception 402 in the UE, a first message indicative of maximum output power for at least the first UL beam and the second UL beam. As noted before, this may involve only identifying the second UL beam and its maximum output power, or optionally identifying maximum output power for both the first and the second UL beam.

At 720 the UE 10 determines any required power adjustment, e.g., responsive to requirements related to EIRP or MPE. This may involve determining 404, based on the first message, information indicative of resulting output power of using the first UL beam and the second UL beam.

At 725 the UE 10 transmits information indicative of usable output power. This information may be indicative of resulting output power of using the first UL beam and the second UL beam, such as required power back-off caused by constructive combination of the first UL beam and the second UL beam, or a measure indicative of combined output power upon transmitting using maximum output power for a first UL beam and a second UL beam. As noted, the information transmission of 725 may be conditionally carried out based on one or more criteria associated with resulting output power caused by using the configuration indicated in the first message.

At 730 the RAN 120 configures the UE 10 for communication using beam pairs based on the received information and transmits a second message. As noted, the second message may acknowledge the instructions conveyed by the first message, or it may comprise new configuration or maximum output power settings.

At 735 the UE 10 is connected over multiple beam pairs, using configuration conveyed in the first message and potentially changed in the second message.

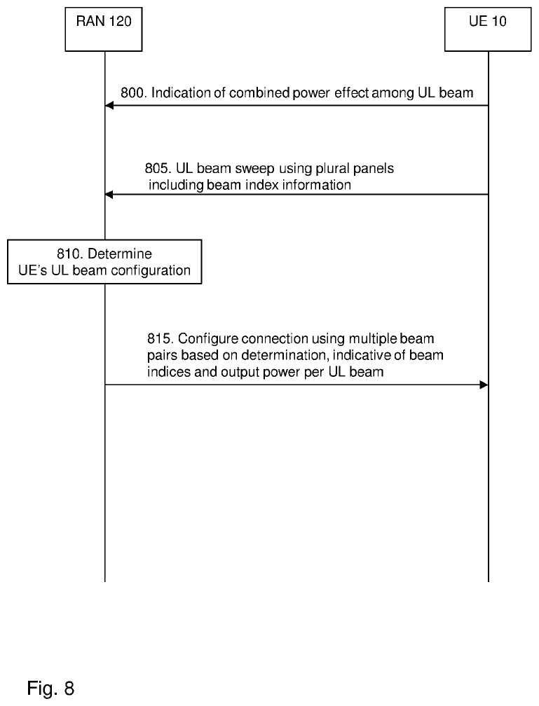

FIG. 8 comprises a signaling diagram, which shows another example of the proposed solution. The left part indicates the RAN 120 and may be carried out by a serving access node 121, or by more than one access node.

800 relates to the UE 10 providing, to the RAN 120, an indication of information related to combined power effect among configurable UL beams. This indication may e.g., provide that for a given tuple (in the example of a two-panel system) of configurations of UL beams, a combined effect associated with output power is obtained in at least a certain direction, such as caused by power aggregation as indicated in FIG. 1. The indication may thus correlate with or indicate an accumulative output power, or an increased required power back-off to be required by the UE 10. The information provided may be indicative of combined limits, or net power effects, and is used for facilitating power control and/or beam pair selection by the RAN 120, typically the serving access node 121. In this context, the information may be indicative of net EIRP, dependent on the resulting power effects in the direction in which aggregate power is maximum.

In some examples, the indication (or information) of 800 may be provided at registration to the wireless network 100, such as at first power on. The indication may be transmitted by the UE as part of, or in conjunction with, UE capability information. In some examples, the RAN 120 may request the indication based on the UE capability information identifying that the UE 10 operates a multi-panel system 314.

In some examples, the indication 800 may comprise the information described above with reference to FIGS. 4 and 6. In this context, the indication 800 may convey information indicative of the described functional relationship between the net power and individual UL beam power, of a combination of any tuple of UL beams.

805 indicates that the UE makes an UL beam sweep using plural panels including beam index information. In this context, the UE 10 may be configured to transmit e.g., SRS or other UL signals using different tuples of configurable UL beams of its multi-panel system 314.

810 indicates that the RAN 120, based on detection of the UL signals transmitted at 805, determines UL beam configuration for the UE 10. In this context, suitable beams (resources) detected in the beam sweep 805 may be evaluated based on the functional relationship obtained by indication 800. This way, the RAN 120 may suitably determine beam pairs for use in (at least) UL communication with the UE 10 and configure related power control of the first and second UL beams, so to satisfy the EIRP limit while also satisfying other targets, such as a throughput target. Step 810 thus corresponds to step 606 of FIG. 6.

815 indicates that the RAN 120 configures connection (at least UL transmission configuration) using multiple beam pairs based on the determination of 810. Configuration of at least UL communication comprises configuration that indicates use of UL beams at the UE 10, identified at 810 and possibly with a determined maximum output power.

An effect obtained is thus that the RAN 120 is provided with improved conditions and tools for configuring a multi-panel UE 10, in view of regulatory limits related to output power.

Although the proposed solution has been shown and described with respect to certain preferred examples, equivalents and modifications will occur to others skilled in the art upon the reading and understanding of the specification. The proposed solution may, inter alia, take the shape of any combination of the features set out herein, and includes any equivalents and modifications falling within the scope of the appended claims.

1. A method carried out in a user equipment (UE) for facilitating configuration of uplink (UL) output power of radio transmission from the UE, wherein the method comprises:
receiving, from an access network, a first message indicative of a first configuration of maximum output power for at least a first UL beam and a second UL beam;
transmitting, to the access network based on the first message, information indicative of resulting output power of using the first UL beam and the second UL beam according to the first configuration.

2. The method of claim 1, wherein said information is indicative of required power back-off caused by combined use of the first UL beam and the second UL beam.

3. The method of claim 1, wherein said information is indicative of combined output power upon transmitting using maximum output power for a first UL beam and a second UL beam.

4. The method of claim 2, wherein said information is indicative of required power back-off or combined output power resulting from replacing one of said first and second UL beams with a third UL beam.

5. The method of claim 1, wherein the step of transmitting is carried out responsive to a parameter value, correlating with the resulting output power, meeting a threshold criterion.

6. The method of claim 1, wherein the first UL beam is configured with a first maximum output power, and wherein the first message identifies the second UL beam and a second maximum output power the second UL beam.

7. The method of claim 1, comprising:
determining said information based on the first configuration.

8. The method of claim 1, further comprising:
receiving, responsive to the transmitted information, a second message associated with the first message.

9. The method of claim 8, wherein the second message is indicative of a second configuration comprising an update of at least one of maximum output power or UL beams according to the first configuration.

10. The method of claim 8, wherein the second message is indicative of an adjustment of uplink duty cycle for the first configuration.

11. The method of claim 1, wherein the first message or the information is indicative of multi-panel UL transmission, wherein the first UL beam is configured using a first panel and the second UL beam is configured using a second panel.

12. A user equipment (UE) comprising:
a radio transceiver,
logic circuitry configured to communicate data, via the radio transceiver, with a radio access network (RAN) wherein the logic is further configured to control the UE to:
receive, from an access network, a first message indicative of a first configuration of maximum output power for at least a first UL beam and a second UL beam;
transmit, to the access network based on the first message, information indicative of resulting output power of using the first UL beam and the second UL beam.

13. (canceled)

14. A method carried out in an access node of an access network for configuration of uplink (UL) output power of radio transmission from a user equipment (UE) wherein the method comprises:
transmitting, to the UE, a first message indicative of a first configuration of maximum output power for at least a first UL beam and a second UL beam;
receiving, from the UE, information indicative of resulting output power of using the first UL beam and the second UL beam, wherein UL connection for the UE is configured based on said information.

15. The method of claim 14, wherein said information is indicative of required power back-off caused by combined use of the first UL beam and the second UL beam.

16. The method of claim 14, wherein said information is indicative of combined output power upon transmitting using maximum output power for a first UL beam and a second UL beam.

17. The method of claim 14, wherein said information is indicative of required power back-off or combined output power resulting from replacing one of said first and second UL beams with a third UL beam.

18. The method of claim 14, wherein the information is received out responsive to a parameter value, correlating with the resulting output power, meeting a threshold criterion.

19. The method of claim 14, wherein the first UL beam is configured with a first maximum output power, and wherein the first message identifies the second UL beam and a second maximum output power the second UL beam.

20. The method of claim 11, further comprising:
transmitting, responsive to the received information, a second message associated with the first message.

21-30. (canceled)
